(19) United States
(12) Patent Application Publication
(10) Pub. No.: US 2014/0337399 A1
(43) Pub. Date: Nov. 13, 2014

(54) METHOD OF GENERATING RANDOM NUMBERS III

(71) Applicants: Hiroshi NAKAZAWA, Osaka (JP); Naoya NAKAZAWA, Osaka (JP)

(72) Inventors: Hiroshi NAKAZAWA, Osaka (JP); Naoya NAKAZAWA, Osaka (JP)

(21) Appl. No.: 13/892,991

(22) Filed: May 13, 2013

(51) Int. Cl. G06F 7/58

(52) U.S. Cl. CPC G06F 7/582
USPC 708/254

(57) ABSTRACT

A system and method of generating uniform and independent random numbers is given by comprising two distinct odd primes that give an odd integer and an even integer, together with by taking an integer exponent and an integer exponent, by forming the composite modulus by taking a primitive root modulo and a primitive modulo and giving the multiplier modulo by either the system of congruence relations, any of which determines the multiplier modulo uniquely, by taking an initial value coprime. The method generates the sequence of integers by recursive congruence relations and gives an output of uniform and independent random numbers.

### FIELD OF INVENTION

The present invention relates to methods of obtaining uniform and independent random numbers on computers. More specifically, the methods relate to the multiplicative congruential generation that includes:

1. a positive integer d called modulus,

2. a positive integer z called multiplier that is coprime with d, and

3. a positive integer n called initial value or seed coprime with d, emits a sequence of integers {r₁, r₂, r₃, . . . } from recursive congruence relations

r₁≡n,rⱼ₊₁≡zrⱼ mod(d),0<rⱼ<d,j=1,2,3, . . . , Eq. 1

and gives an output sequence {v₁, v₂, v₃, . . . } in the interval (0, 1) by realizing the division

vⱼ:=rⱼ/d,j=1,2,3, . . . Eq. 2

A multiplicative congruential generator for uniform and independent random numbers with the modulus d, the multiplier z and the initial value n will also be noted as (d, z, n) symbolically.

### BACKGROUND

A Random Number Generator (RNG) is a computational or physical device designed to generate a sequence of numbers or symbols that lack any pattern, i.e. appear random.

The many applications of randomness have led to the development of several different methods for generating random data. Many of these have existed since ancient times, including dice, coin flipping, the shuffling of playing cards, the use of yarrow stalks, and many other techniques. Because of the mechanical nature of these techniques, generating large numbers of sufficiently random numbers (important in statistics) required a lot of work and/or time. Thus, results would sometimes be collected and distributed as random number tables. Nowadays, after the advent of computational RNGs, a growing number of government-run lotteries, and lottery games, are using RNGs instead of more traditional drawing methods. The use of RNGs arises now in gambling, statistical sampling, computer simulation, cryptography, completely randomized design, and other areas where the required statistical precision, namely how precisely the generated random numbers should realize the assumed statistical distribution, has a large variety. The present invention is related to the rapid increase of applications of large-scale scientific and mathematical simulations that call more than ever for higher precision of the statistical nature of generated random numbers. In one extreme end, numerical simulations of stochastic differential equations (SDEs) arise in various scientific, technological or even economical applications. Schemes for SDEs with higher precision realize faster computation, but it is only on the basis of the precise realization of random number statistics. The precision of the statistics of random numbers is only remotely tied to the nature of the unpredictability which is fundamental, typically in cryptography. The now popular Mersenne twister is at the one end of the highest position for this unpredictability with its gigantic length of the period and the nominal equidistribution property. Yet, the precision can be realized solely and indispensably by statistical tests valid on properties over the whole period of generated random number sequences, and the tremendous period length of Mersenne twister impedes any systematic statistical tests of generated random numbers. Note also that the equidistribution property is insufficient in ensuring the statistical precision: There are a vast number of ways to choose primitive polynomials that realize the same equidistribution property, and an arbitrary choice can hardly hit on statistically excellent outputs. Mersenne twister still lacks any theoretical or empirical basis to selects one of such primitive polynomials as its own. In this regard a fundamental technological point is that any RNGs on computers should deal exclusively with integer sequences. This is necessitated by the requirement to reproduce the identical sequence of random numbers with arbitrarily large length on demand of users, which should be realized without the hindrance of truncation and round-off errors. Another reason for this necessity is the requirement of transportability, that one and the same random number sequence should be generated on any computers or in any computer languages. Though seemingly obstructive, these necessities in fact provide a great mathematical convenience by the fact that any finite sequence of integers {x₁, x₂, . . . , x_{T}}, that is to give a sequence of uniform and independent random numbers as {x₁/z, x₂/z, . . . , x_{T}/z} with a large integer z, may be approximated by the so-called multiplicative congruential RNGs. And any multiplicative congruential RNGs are admitted readily to spectral tests, one of the most powerful of tests on the precision of the statistics of random number sequences. The first of above noted points, significant by its mathematical and conceptual contents, should here be accounted for fully. Any sequence of integers {x₁, x₂, . . . , x_{T}}, each of which are in the range from 0 to z−1 with a large integer z, may be regarded as corresponding to the base z expansion of a rational number x=0. \dot{x}₁ x₂ . . . \dot{x}_{T} with period T. Multiplication of x with z^{T} gives that x has the quotient expression x=n/d with d:=z^{T}−1, n:=x₁z^{T-1}+x₂z^{T-2}+ . . . +x_{T} z⁰. Integers {x₁, x₂, . . . , x_{T}} are thus obtained by the arithmetic process of division of n by d, and there holds the equation zrⱼ=xⱼ₊₁d+rⱼ₊₁ with 0<rⱼ<d for j=1, 2, . . . implying that the division of the j-th remainder rⱼ multiplied by the base z with d is to give the next quotient xⱼ₊₁ and the next remainder rⱼ₊₁. Another expression of this equation is rⱼ₊₁≡zrⱼ mod(d). Division of the original equation by zd gives |rⱼ/d−xⱼ₊₁/z|=rⱼ₊₁/zd<1/z, the key estimate. Imagine the usual circumstance for random numbers with d and z large than 2³². The term rⱼ/d is precisely the j-th output of a multiplicative congruential RNG with the modulus d and the multiplier z, and the inequality proves that any sequence {x₁/z, x₂/z, . . . , x_{T}/z} of uniform and independent random numbers, as it should be realized on computers, is approximated by a multiplicative congruential one {r₁/d, r₂/d, . . . , r_{T}/d}. Since the sequence {x₁/z, x₂/z, . . . , x_{T}/z} of uniform and independent random numbers is arbitrary, the finding of this structure dismisses some of our concerns on the representation of uniform and independent random numbers; if a sequence of such random numbers should exist at all, it should be represented by a multiplicatic congruential sequence. Efforts may be safely concentrate on good multiplicative congruential RNG for uniform and independent random numbers with a long period required.

### SUMMARY

The present invention provides a method to obtain uniform and independent random numbers with long periods and certified statistical quality, which may be realized in operating systems on computers with the smallest computational cost.

The invention claims a method of obtaining uniform and independent random numbers comprising:

1. two odd distinct primes p₁ and p₂, and their integer exponents i₁≧1 and i₂≧1, which are restricted in the ways (1a)-(1c) noted below,

(1a) the integer q₁:=(p₁−1)/2 is odd and the integer q₂:=(p₂−1)/2 is even,

(1b) integers q₁{p₁̂(i₁−1)} and q₂ {p₂̂(i₂−1)} are coprime,

(1c) the case i₁=i₂=1 is excluded,

2. primitive roots z₁ and z₂ of prime-power moduluses d₁:=p₁̂i₁ and d₂:=p₂̂i₂, respectively,

3. the modulus d=d₁d₂

4. the multiplier z coprime with d=d₁d₂ and determined by the system of congruence relations

z≡z₁ mod(d₁=p₁̂i₁),z≡z₂ mod(d₂=p₂̂i₂) Eq. 3

or by the system of congruence relations

z≡−z₁ mod(d₁=p₁̂i₁),z≡z₂ mod(d₂=p₂̂i₂), Eq. 4

both system of which specify z uniquely in the sense of modulo d,

5. an arbitrary integer n coprime with d.

The method constructs a sequence of integers {r₁, r₂, . . . } recursively by

r₁≡n,rⱼ₊₁≡zrⱼ mod(d),0<rⱼ<d,j=1,2, . . . Eq. 5

and gives the output sequence {v₁, v₂, . . . } for uniform and independent random numbers by realizing the arithmetic,

vⱼ:=rⱼ/d,0<vⱼ<1,j=1,2, . . . Eq. 6

Structures of the multiplicative congruential generator (d, z, n) as summarized in the preceding paragraph ensure that the emitted random number sequence has the usable period

T′=2q₁{p₁̂(i₁−1)}×q₂{p₂̂(i₂−1)} Eq. 7

and realize the optimal efficiency measure τ:=(the usable period/the modulus)=T′/d≈½;. The generator (d, z, n) with a modulus formed by two odd-prime-powers has another great merit originating from the inherent shuffling mechanism. For, the sequence {n, nz, nz², . . . } satisfies

Nz^{j-1}≡nₖ(zₖ)^{j-1} mod(dₖ),j=1,2, . . . ,nₖ:≡n mod(dₖ),k=1,2, Eq. 8

and the following expression holds true by Sun Tzu's theorem,

nz^{j-1}≡U₁n₁(z₁)^{j-1}+U₂n₂(z₂)^{j-1} mod(d),j=1,2, . . . , Eq. 9

with integers U₁, U₂ determined by component moduluses d₁ and d₂. The generator (d, z, n) may generate a sequence of random integers by shuffling sequences from component generators (d₁, z₁, n₁) and (d₂, z₂, n₂). In the event that component generators (d₁, z₁, n₁) and (d₂, z₂, n₂) are chosen by their respective spectral tests, the likelihood of hitting a good generator (d, z, n) as the synthesis is expected technologically to be well increased. Shuffling may be effective when d₁, d₂ are similar (but not too close) in magnitude, so that the adequate choice will be d₁≈d₂≈d^{1/2}, with d^{1/2}<<d in cases of practical importance. This setting facilitates decisively the computation of spectral tests of component multipliers, and of the combined multiplier as well.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 shows an example computing device that may be used to implement features described above; and

FIG. 2 shows a tablet computer that is a more specific example of the computing device of FIG. 1.

### DETAILED DESCRIPTION OF THE PREFERRED EMBODIMENT(S)

It is to be understood that the figures and descriptions of the present invention have been simplified to illustrate elements that are relevant for a clear understanding of the present invention, while eliminating, for the purpose of clarity, many other elements found in computing systems and number generators. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In order to keep the clarity of notations the power pⁱ will be denoted as p̂i when confusion is feared. The present invention has its concern in the use of a specific form of the modulus d=(p₁̂i₁)×(p₂̂i₂), where p₁ and p₂ are odd primes and exponents i₁≧1 and i_{2≧1} are integers. The integer q₁:=(p₁−1)/2 is assumed odd and the integer q₂:=(p₂−1)/2 is assumed even. The multiplier z is defined by the system of congruence relations:

z≡±z₁ mod(p₁̂i₁),z≡z₂ mod(p₂̂i₂), Eq. 10

where z₁ is a primitive root (or a generating element) modulo the odd-prime-power modulus p₁̂i₁ and z₂ is a primitive root modulo the odd-prime-power modulus p₂̂i₂. Congruence relations in this system determine z uniquely modulo d by the theorem of Sun Tzu (or by the Chinese remainder theorem). The setting i₁=i₂=1 and the cases of the specification

z≡±z₁ mod(p₁),z≡z₂ mod(p₂), Eq. 11

was submitted for patents to USPTO already as Ser. Nos. 12/379,964 and 13/105,351. The present invention generalizes exponents i₁ and i₂ to all cases of i₁>1 and i₂>1, with the exclusion of the case i₁=i₂=1.

Computers invariably have finite amounts of memory, and any generators of random numbers are destined to give only finite periods, if they are to emit random numbers in any reproducible way. In order for a generating method of random numbers to be of technological value, its period T should be large enough to sustain simulations. In this regard, consider a multiplicative congruential generator (d, z, n) with an odd prime modulus d=p and its primitive root multiplier z. The period T of the sequence is given as T=φ(p)=p−1 by Fermat's little theorem with the Euler's function φ. This stipulates that z^{T/2}≡−1 mod(p) should be true, that the last half of the sequence (as viewed with the change of sign) is identical with the first half, and that only the first half is usable for independent random numbers. Any multiplicative congruential sequence generated by (d, z, n) has its usable period T′ for the independent random number sequence as T′:=T/2, if the cyclic sequence {1, z, z², . . . } modulo d has an even period T and gives z^{T/2}≡−1 mod(d). An even T does not always imply z^{T/2}≡−1 mod(d). The factor τ:=T′/d characterizes the efficiency of a multiplicative congruential generator (d, z, n), because the computation of consecutive random numbers becomes heavy in proportion to d and also by statistical reasons to be described later. There exists a general upper bound for this efficiency in the form that z cannot exceed ½. (d, z, n) generators aimed in the present invention all realize the largest τ≈½.

A method of generating uniform and independent random numbers is given by comprising two distinct odd primes that give an odd integer and an even integer, together with by taking an integer exponent and an integer exponent, by forming the composite modulus by taking a primitive root modulo and a primitive modulo and giving the multiplier modulo by either the system of congruence relations, any of which determines the multiplier modulo uniquely, by taking an initial value coprime. The method generates the sequence of integers by recursive congruence relations and gives an output of uniform and independent random numbers.

Let p₁ and p₂ be distinct odd primes, exponents i₁≧1 and i₂≧1 be integers, the integer z₁ be a primitive root modulo d₁:=pᵢ̂i₁ and the integer z₂ be a primitive root modulo d₂:=p₂̂i₂. Define integers q₁:=(p₁−1)/2 and q₂:=(p₂−1)/2, and assume that q₁ is odd and q₂ is even. Assume that {p₁̂(i₁−1)}q₁ and {p₂̂(i₂−1)}q₂ are taken mutually coprime. Define finally d:=d₁d₂=(p₁̂i₁)×(p₂̂i₂). Then the following assertions hold true.

First, the integer z specified modulo d uniquely by the system of congruence relations

z≡z₁ mod(d₁=p₁̂i₁),z≡z₂ mod(d₂=p₂̂i₂), Eq. 12

gives, together with an arbitrary initial value n coprime to d, the multiplicative congruential generator (d, z, n) that realizes the period T=2{p₁̂(i₁−1)}q₁×{p₂̂(i₂−1)}q₂ with the largest efficiency measure τ≈½.

Second, the integer z specified modulo d uniquely by the system of congruence relations

z≡−z₁ mod(d₁=p₁̂i₁),z≡z₂ mod(d₂=p₂̂i₂), Eq. 13

gives, together with an arbitrary initial value n coprime to d, the multiplicative congruential generator (d, z, n) that realizes the period T=2{p₁̂(i₁−1)}q₁×{p₂̂(i₂−1)}q₂ with the largest efficiency measure τ≈½, though −z₁ is not a primitive root modulo d₁=p₁̂i₁.

Since component moduluses d₁=p₁̂i₁ and d₂=p₂̂i₂ are coprime mutually, Sun Tzu's theorem gives that z is determined modulo d=d₁d₂ uniquely by the noted system of congruence relations, and that an explicit form of z is given by

z≡U₁z₁+U₂z₂ mod(d),Uⱼ=δⱼₖ mod(dₖ), Eq. 14

with integers U₁ and U₂ depending only on component moduluses d₁=p₁̂i₁ and d₂=p₂̂i₂. The cyclic sequence {1, z, z², . . . } generated by z modulo d is seen at once to be a shuffling of component cyclic sequences and gives,

z^{j-1}≡U₁z₁^{j-1}+U₂z₂^{j-1} mod(d),j=1,2, . . . , Eq. 15

with the least common multiple period T that is even,

T=LCM(T₁,T₂)=T₁T₂/2,T₁:=2q₁{p₁̂(i₁−1)},T₂:=2q₂{p₂(i₂−1)}. Eq. 16

Therefore, z^{t}≡−1≡d−1 mod(d) can arise, if at all, only at at t=T/2=T₁T₂/4. The assumption that q₂ is even gives an integer for T₂/4, and we have

z^{T/2}≡z₁̂(T₁T₂/4)≡{z₁̂(T₁)}̂(T₂/4)≡1 mod(d₁=p₁̂i₁), Eq. 17

which proves that z^{T/2}≠1 mod(d). Hence the whole length T of the sequence may be used for independent random numbers, and we have

τ=T/d=(T₁T₂/2)/{(p₁̂i₁)×(p₂̂i₂)}≈½. Eq. 18

Since z₁ is a primitive root modulo p₁̂i₁, the cyclic sequence {1, z₁, z₁², . . . } has the following even period T₁ in the same modulus,

T₁:=φ(p₁̂i₁)=p₁̂(i₁−1)φ(p₁)=2q₁{p₁̂(i₁−1)},q₁:=(p₁−1)/2, Eq. 19

and z₁̂(T₁/2)≡−1 mod(p₁̂i₁) holds true. However, the assumption that q₁ is odd implies T₁/2=q₁{p₁̂(i₁−1)} is odd, and

(−z₁)̂(T₁/2)≡−(−1)≡1 mod(p₁̂i₁). Eq. 20

Therefore, for the case i₁=1, the cyclic sequence {1, −z₁, (−z₁)², . . . } modulo p₁̂i₁ realizes the period T₁/2 and −z₁ is not a primitive root modulo p₁̂i₁. For all these complications the multiplier z characterized by

z≡−z₁ mod(p₁̂i₁),z≡z₂ mod(p₂̂i₂), Eq. 21

has its cyclic sequence modulo d with the least common multiple period T,

T:=LCM(T₁/2,T₂)=2q₁{p₁̂(i₁−1)}×q₂{p₂̂(i₂−1)}, Eq. 22

which is a multiple of 4 by the assumption that q₂ is even. Therefore, T/2 is even, and z^{T/2} modulo p₁̂i₁ is equivalent to an even power of (−z₁)̂T₁. This proves z^{T/2}≡1 mod(p₁̂i₁) together with z^{T/2}≠−1 mod(d). Thus, the whole length T of the cyclic sequence generated by z may be used for independent random numbers, implying τ=T/d≈½.

The largest efficiency τ≈½ of a multiplicative congruential generator (d, z, n) is desirable but not sufficient for the generated random numbers to have excellent statistics. The multiplicative congruential generator (d, z, n) with a Mersenne prime modulus d=p=2³¹−1 may be tested exhaustively for all of its primitive roots for the multiplier z and was found by Fishman and Moore (1986) that 7.669×10⁻⁵% of primitive roots pass the criterion. Significant implications of this small number will be that some tests over the whole length of the random number sequence are indispensable for us to grasp at excellent random number sequences out of the mediocre or bad multitudes, and that the circumstance will be universal to any sort of RNGs. Yet, merits of RNGs of multiplicative congruential type are that these may be run on computers with the smallest computational load, may readily be tested spectrally, and may be designed to have large efficiency τ≈½, not to mention the stated theoretical significance that they represent any sequences from RNGs on computers.

Let (d, z, n) be a multiplicative congruential generator with an arbitrary modulus d and an arbitrary multiplier z coprime with d. Denote {r₁, r₂, . . . } for the output sequence of integers defined at this place simply by

r₁≡n mod(d),rₖ₊₁≡zrₖ mod(d),k=1,2, . . . Eq. 23

Denote the L-tuple starting from rₘ as Pₘ:≡(rₘ, rₘ₊₁, . . . , r_{m+L-1}) and regard it as a point in the L-dimensional Euclidean space E_{L}; Pₘ will also be noted loosely as a position vector. These points {P₁, P₂, . . . }, together with all points that have coordinates congruent to them modulo d, occupy a portion of lattice points in E_{L}. Define L vectors in E_{L} by the integer coordinates,

$${e}_{1} := ( 1 , z , {z}^{2} , … , {z}^{L - 2} , {z}^{L - 1} ) , \\ {e}_{2} := ( 0 , d , 0 , … , 0 , 0 ) , \\ {e}_{3} := ( 0 , 0 , d , … , 0 , 0 ) , \\ … … … \\ {e}_{L - 1} := ( 0 , 0 , 0 , … , d , 0 ) , \\ {e}_{L} := ( 0 , 0 , 0 , … , 0 , d ) . \qquad Eqs . 24 \text{-} 28$$

The point or the position vector Pₘ may be denoted Pₘ≡nz^{m-1}e₁ mod (d). Additions of vectors e₂, e₃, . . . , e_{L} realize geometrically d-translations along coordinate axes 2, 3, . . . , L in E_{L}. As regards the d-translation along the first axis the addition of the vector e₁′ formed by an integral linear combination

e₁′:=de₁−ze₂−z²e₃− . . . −z^{L-1}e_{L}=(d,0,0, . . . ,0,0) Eq. 29

plays the role. Thus, points with position vectors {Pₘ|m=1, 2, . . . } and the d-translations along axes are all expressed as integral linear combinations of vectors {e₁, e₂, . . . , e_{L}} which are manifestly linearly independent (i.e. with positive determinant d^{L-1}). These are all in the lattice spanned by these basis vectors. This lattice may be denoted as G(e₁, e₂, . . . , e_{L}); we employ the simplification G_{L}(d, z), because basis vectors are determined by d and z.

Denote C_{L}(d) for an L-dimensional hypercube in Eₗ with sides 0≦xⱼ<d along the j-th coordinate axes. The number of lattice points of G_{L}(d, z) in the hypercube C_{L}(d) is d. Take any lattice vector x=c₁e₁+c₂e₂+ . . . +C_{L}e_{L} with integers c₁, c₂, . . . , C_{L}. The first coordinate of x is c₁, and there exist d values of c₁ that satisfy 0≦c₁<d. Fix c₁ at a value in this range. The second coordinate of x is then x₂=c₁z+c₂d, and the requirement 0≦x₂<d determines c₂ uniquely by c₁ and d. Integers c₃, c₄ . . . are likewise determined uniquely. Hence precisely d lattice vectors x or lattice points exist in the cube C_{L}(d).

Now let (d, z, n) be any multiplicative congruential generator. For any dimension L the consecutive L-tuples from (d, z, n) in its usable period can occupy only less than half of points of G_{L}(d, z) lattice, because of the efficiency measure z=(the usable period/d)=T′/d<½.

Spectral tests give valuations on the geometrical configuration of the lattice G_{L}(d, z) introduced above, usually for 2≦L≦6. Inspections of possible lattice configurations for cases with L=2 in the Euclidean plane will give the intuitive comprehension of the content of spectral tests. If d lattice points in the hypercube C_{L}(d) is distributed uniformly and isotropically to all directions, then the valuation of spectral test is high. A complication is that this valuation is not so easy with basis vectors or bases {e₁, e₂, . . . , e_{L}} of the lattice G_{L}(d, z). Rather, a different set of integer basis vectors, {f₁, f₂, . . . , f_{L}} that form the reciprocal lattice, is more convenient. Basis vectors or bases of the reciprocal lattice are defined by inner products with basis vectors:

(eₖ,fₗ)=dδₖₗ,1≦k,l≦L. Eq. 30

This implies that the matrix formed by {f₁, f₂, . . . , f_{L}} transposed is the inverse matrix divided by d of the matrix formed by {e₁, e₂, . . . , e_{L}}. Explicit forms of reciprocal bases are:

$${f}_{1} = ( d , 0 , 0 , … , 0 , 0 ) , \\ {f}_{2} = ( - z , 1 , 0 , … , 0 , 0 ) , \\ {f}_{3} = ( - {z}^{2} , 0 , 1 , … , 0 , 0 ) , \\ … … … \\ {f}_{L - 1} = ( - {z}^{L - 2} , 0 , 0 , … , 1 , 0 ) , \\ {f}_{L} = ( - {z}^{L - 1} , 0 , 0 , … , 0 , 1 ) . \qquad Eqs . 31 \text{-} 35$$

The reciprocal lattice consists of vectors that are integral linear combinations of these bases, typically v=c₁f₁+c₂f₂+ . . . +C_{L}f_{L} with any set of integers c₁, c₂, . . . , C_{L}. Since all coordinates of v are integers, there exists the shortest vector among non-zero vectors with length greater or equal to 1. Denote b_{L}(d, z) for this positive shortest length. Some geometrical restrictions intervene in the Euclidean space E_{L} that give the theoretical upper bound B_{L}(d) for this shortest value b_{L}(d, z). This upper bound is listed in Table I below.

TABLE I
The geometrical upper bound B_{L}(d) of the shortest length b_{L}(d, z)

| dimension L | 2 | 3 | 4 | 5 | 6 |
|---|---|---|---|---|---|
| B_{L} (d) | 2^{1/2}3^{-1/4}d^{1/2} | 2^{1/6}d^{1/3} | 2^{1/4}d^{1/4} | 2^{3/10}d^{1/5} | 2^{1/2}3^{-1/12}d^{1/6} |
| | ≈1.075d^{1/2} | ≈1.122d^{1/3} | ≈1.189d^{1/4} | ≈1.231d^{1/5} | ≈1.290d^{1/6} |
| | =O(d^{1/2}) | =O(d^{1/3}) | =O(d^{1/4}) | =O(d^{1/5}) | =O(d^{1/6}) |

Since B_{L}(d) refers to the geometrically ideal reciprocal lattice which (along with the geometrically ideal original lattice) requires irrational Cartesian components for their description, there holds b_{L}(d, z)<B_{L}(d) invariably.

The valuation of spectral tests may now be defined. The ratio is

μ_{L}(d,z):=B_{L}(d)/b_{L}(d,z)>1,2≦L≦6. Eq. 36

If this ratio μ_{L}(d, z) is closer to 1, the generator (d, z, n) has fewer reasons to be denied of the statistical uniformity and independence of random numbers they generate. Implications of values in L=2 cases,

μ₂(d,z)≈1.05,1.10,1.15, . . . ,1.50, Eq. 37

have been depicted by Nakazawa and Nakazawa (2011), in “Spectral tests of primitive roots for primes up to 101027 and of multiplicative congruential random number sequences generated by pairs of primitive roots.” A glance over them will give clear geometrical image behind the above noted valuations. Fishman and Moore initiated the use of the criterion

μ_{L}(d,z)<1.25,2≦L≦6, Eq. 38

for the excellence of a primitive root multiplier z with respect to the Mersenne prime modulus d=2³¹−1=2147483647, which is highly versatile and useful beyond this special case. Examinations of multipliers under this or other criterion require the search of the shortest reciprocal lattice vectors. Expressions of reciprocal lattice vectors with bases {f₁, f₂, . . . , f_{L}} are yet not so convenient to this end; the expression of the reciprocal lattice vector v=(j₁, j₂, . . . , j_{L}) with integer Cartesian coordinates should be employed by its simple relation to ∥v∥=(j₁²+j₂²+ . . . +j_{L}²)^{1/2}, the vector length. It is not that every such integer vector v belongs to the reciprocal lattice, but the discrimination may be performed readily. The congruence relation

j₁+zj₂+z²j₃+ . . . +z^{L-1}j_{L}≡0 mod(d), Eq. 39

is necessary and sufficient for an integer vector v=(j₁, j₂, . . . , j_{L}) to be in the reciprocal lattice of dimension L≧2 for the modulus d and the multiplier z.

For, the reciprocal lattice vector has the expression v=c₁f₁+c₂f₂+ . . . +c_{L}f_{L} by a set of integers {c₁, c₂, . . . , c_{L}}. Its Cartesian coordinates are

v=(j₁,j₂,j₃, . . . ,j_{L}),j₁=dc₁−zc₂−z²c₃− . . . −z^{L-1}c_{L}, Eq. 40

with j₂=c₂, j₃=c₃, . . . , j_{L}=C_{L}. This implies

j₁+zj₂+z²j₃+ . . . +z^{L-1}j_{L}=dc₁≡0 mod(d). Eq. 41

Therefore, the congruence relation Eq. 40 is a necessary condition for v to be in the reciprocal lattice. Conversely, if Cartesian coordinates of v=(j₁, j₂, . . . , j_{L}) fulfill this congruence relation, some integer j′ exists and gives

j₁+zj₂+ . . . +z^{L-1}j_{L}=j′d,j₁=j′d−zj₂−z²j₃− . . . −z^{L-1}j_{L}, Eq. 42

v=(j₁,j₂, . . . ,j_{L})=j′f₁+j₂f₂+ . . . +j_{L}f_{L}. Eq. 43

Hence v is a reciprocal lattice vector, and the sufficiency follows.

In the usual circumstance for a multiplicative congruential generator (d, z, n) the modulus d is a very large integer. Therefore, d^{1/L}<<d holds true for any L=2, 3, . . . . The geometrical restriction, that B_{L}(d) z O(d^{1/L})>b_{L}(d, z) holds for the shortest length b_{L}(d, z) of the L-dimensional reciprocal lattice vector v=(j₁, j₂, . . . , j_{L}) in Cartesian coordinates, allows us to search for b_{L}(d, z) only over integers j₁, j₂, . . . , j_{L} satisfying Eq. 40 within the range

−B_{L}(d)<jₖ<B_{L}(d),1≦k≦L,2≦L≦6. Eq. 44

In search for the shortest reciprocal lattice vector v=(j₁, j₂, . . . , j_{L}) in Cartesian coordinates, therefore, the condition j₁+zj₂+z²j₃+ . . . +z^{L-1}j_{L}≡0 mod(d) may be solved for j₁ as j₁≡−zj₂−z²j₃− . . . −z^{L-1}j_{L} mod(d). Noting that v and −v have the same length, a restriction of 0≦j₁≦B_{L}(d)≈d^{1/L} may be performed. The search of such shortest vector should be on all combinations of L−1 integers j₂, j₃, . . . , j_{L} sweeping over approximately 2B_{L}(d) values in the interval (−B_{L}(d), B_{L}(d)), namely over the total number N_{L}(d):={2B_{L}(d)}^{L-1} of integer sets. They are listed below in Table II.

TABLE II
Number N_{L}(d) of integer sets to be swept over in the L-th degree
spectral test of a (d, z, n) generator

| degree L | 2 | 3 | 4 | 5 | 6 |
|---|---|---|---|---|---|
| N_{L}(d) | ≈2.150d^{1/2} | ≈5.036d^{2/3} | ≈13.45d^{3/4} | ≈36.74d^{4/5} | ≈114.3d^{5/6} |

Consideration of the number of candidate multipliers to be tested should be given. We first simplify the problem to the case of Fishman and Moore, the odd prime modulus d=p and its primitive roots. There may be some symmetries. A primitive root z and its inverse modulo p give the identical performance in spectral tests. And a primitive root z gives −z that has the identical valuation in spectral tests, even though the latter is not a primitive root in the case that the integer q=(p−1)/2 is odd; note that both of +z give the same performance measure τ=(usable period)/p≈½. The spectral tests should sweep over all primitive roots of the modulus d=p. The expression of all primitive roots by powers of one of them readily shows that an odd prime d=p has φ(φ(p))=φ(p−1) primitive roots. A general evaluation of this Euler's function φ(p−1) is not easy. Since p−1 is even, however, the estimate φ(p−1)≦(p−1)/2≈d/2 is certain. There may of course be an odd prime with many prime factors for p−1, and φ(p−1) is far smaller. However, the choice of such a prime modulus may imply too few primitive roots to have abundant excellent multipliers. A rough estimate φ(p−1)≈p/2 provides Mersenne prime p=2³¹−1 with φ(p−1)≈0.249p. Table III below tabulates the number O_{L}(d=p)=φ(p−1)N_{L}(d=p) of integer sets to be examined in the L-th degree spectral tests.

TABLE III
Number O_{L}(p) := φ(p − 1)N_{L}(p) of integer sets to be swept over
in the L-th degree spectral tests exhausting primitive roots of a single
odd prime modulus d = p with the approximation φ(p − 1) ≈ d/2

| degree L | 2 | 3 | 4 | 5 | 6 |
|---|---|---|---|---|---|
| O_{L}(d) | ≈1.075d^{3/2} | ≈2.518d^{5/3} | ≈6.725d^{7/4} | ≈18.37d^{9/5} | ≈57.15d^{11/6} |

Take now a modulus d=d₁d₂, dₖ=(pₖ)̂iₖ, k=1, 2. The strategy is as follows.

1. Design the magnitude of d z 2T′ for the usable period T′ so as to be sufficient for needs of planned simulations.

2. Choose odd primes p₁, p₂ and their exponents i₁, i₂ so as for d₁≈d₂≈d^{1/2} to hold. Values of d₁ and d₂ too near should be avoided. Also, primes p₁, p₂ should be chosen in such a way that q₁=(p₁−1)/2 is odd and q₂=(p₂−1)/2 is even.

3. Perform exhaustive spectral tests of degrees L=2, 3, . . . , 6 over every primitive root z₁ of d₁, select top N excellent ones, and save them in memory. N≈2¹⁰ might suffice for practical use. Perform likewise exhaustive spectral tests for every primitive root z₂ of d₂, select, and store N excellent ones.

4. Take consecutively N² pairs (z₁, z₂) of selected excellent primitive roots, and solve the system of congruence relations

z≡±z₁ mod(d₁),z≡z₂ mod(d₂) Eq. 45

to obtain the multiplier z for the modulus d=d₁d₂. Perform second stage spectral tests of the generator for the modulus d and the multiplier z, starting from the 2nd degree and recording passers, then moving to third degree tests over remainders, and so forth.

In the first stage exhaustive spectral tests of this strategy, a primitive root multiplier z₁ under the modulus d₁=(p₁)̂(i₁)≈d^{1/2} involves N_{L}(d₁)≈N_{L}(d^{1/2}) integer sets to be examined. And the total number of primitive roots is

φ(φ(d₁))=qφ(φ{(p₁)̂(i₁−1)(p₁−1)})={(p₁)̂(i₁−2)}(p₁−1)φ(p₁−1)≈(p₁)̂(i₁−1)φ(p₁−1)<d^{1/2}. Eq. 46

Since the initial value is irrelevant in spectral tests, we denote briefly (d, z) for the (d, z, n) generator. Approximations dₖ≈d^{1/2} and φ(φ(dₖ))≈dₖ/2 Z d^{1/2}/2 for k=1, 2 give Table IV below for the total number P_{L}(d) of integer sets to be examined in the first stage L-th degree spectral tests.

TABLE IV
The number P_{L}(d) of integer sets arising in the L-th degree exhaustive
first stage spectral tests, totaled for both of (d₁, z₁) and (d_{2,} z₂)
generators with approximations d₁ ≈ d₂ ≈ d^{1/2}.

| degree L | 2 | 3 | 4 | 5 | 6 |
|---|---|---|---|---|---|
| P_{L}(d) | ≈2.150d^{3/4} | ≈5.036d^{5/6} | ≈13.45d^{7/8} | ≈36.74d^{9/10} | ≈114.3d^{11/12} |

Finally, consider the 2nd stage spectral test. Assume a choice of the best-N primitive roots of the modulus d₁=(p₁)̂(i₁)≈d^{1/2} and best-N primitive roots of the modulus d₂=(p₂)̂(i₂)≈d^{1/2}. N≈2¹⁰ will presumably be sufficient. Taking N² pairs (z₁, z₂) of primitive roots to construct the multiplier z under the modulus d=d₁d₂ and proceed to L-th degree spectral test for L=2, 3, . . . , 6. Tabulation of the number of sets of integers to be swept is now easy; we need to multiply Table II with N² to obtain Table V shown below.

TABLE V
Number Q_{L}(d) = N²N_{L}(d) of integer sets to be swept over in the L-th degree second stage
spectral tests for N² pairs of excellent primitive roots under the modulus d = d₁d₂

| degree L | 2 | 3 | 4 | 5 | 6 |
|---|---|---|---|---|---|
| Q_{L}(d) | 2.150N²d ^{1/2} | 5.036N²d ^{2/3} | 13.45N²d ^{3/4} | 36.74N²d ^{4/5} | 114.3N²d ^{5/6} |

The ratio F_{L}(d):=P_{L}(d)/O_{L}(d) gives the reduction rate of the total number of integer sets to be swept over in the pair of first stage L-th degree spectral tests for the two odd-prime power modulus design versus the number of integer sets to be treated in the single odd prime modulus scheme. The ratio S_{L}(d):=Q_{L}(d)/O_{L}(d) similarly gives the rate of reduction of numbers of integer sets to be swept over in the second stage L-th degree spectral tests of N² composite multipliers versus the single odd prime modulus case. These ratios are tabulated below in Table VI.

TABLE VI
Ratios of reduction F_{L}(d) = P_{L}(d)/O_{L}(d) in the first stage
spectral test and S_{L}(d) = Q_{L}(d)/O_{L}(d) for the second stage spectral test

| degree L | 2 | 3 | 4 | 5 | 6 |
|---|---|---|---|---|---|
| F_{L}(d) | 2/d^{3/4} | 2/d^{5/6} | 2/d^{7/8} | 2/d^{9/10} | 2/d^{11/12} |
| S_{L}(d) | 2N²/d | 2N²/d | 2N²/d | 2N²/d | 2N²/d |

Recent supercomputers realize 1.6×10¹⁶=253.15 flops. If a computing program requires one random number in 2³ floating point operations, such a computer will consume 2^{50.15}, 2^{58.96} or 2^{63.87} random numbers in a second, in a day or in a month, respectively. If these random numbers are to be supplied from a (d, z, n) generator with the efficiency τ≈½, the modulus d should be as large as d=2⁶⁵ at present. In the future, the speed of computers will increase, and the modulus d of a (d, z, n) generator should be increased in proportion. The matter may be looked at inversely. The number of cases of integers to be treated in spectral tests may be increased only in proportion to the computer speed. Hence the form of the dependence on d of O_{L}(d) in Table III indicates computational difficulties arising with exhaustive spectral tests in single odd prime modulus schemes. In contrast, Tables IV and V reveal the recovery of computability by two odd-prime-power modulus designs. For all such achievements, however, all tables show that spectral tests become harder for larger L. Therefore, the preparation of two-odd-prime-power generators by spectral tests should be started from the degree L=2 and be discarded of non-passable multipliers preventing time-consumptive higher degree computations. Thus, passers of the desired high performance in L=2 tests should be tabulated in a file. Then the file should be read into subfiles, candidate multipliers in different subfiles should be processed in parallel in the test of the next degree L, and procedures should be repeated with L increased. Many other minute optimizations will simultaneously be needed: Multiplication of numbers should be replaced with addition if possible; use of function mod had better be avoided if simple subtraction suffices; and so forth. Spectral tests for larger moduluses are still a challenging subject. A simpler strategy to tighten the criterion for passers can be useful since more retirees will ease the burden of spectral tests. But this might be risky since a too tight criterion may extinguish passers.

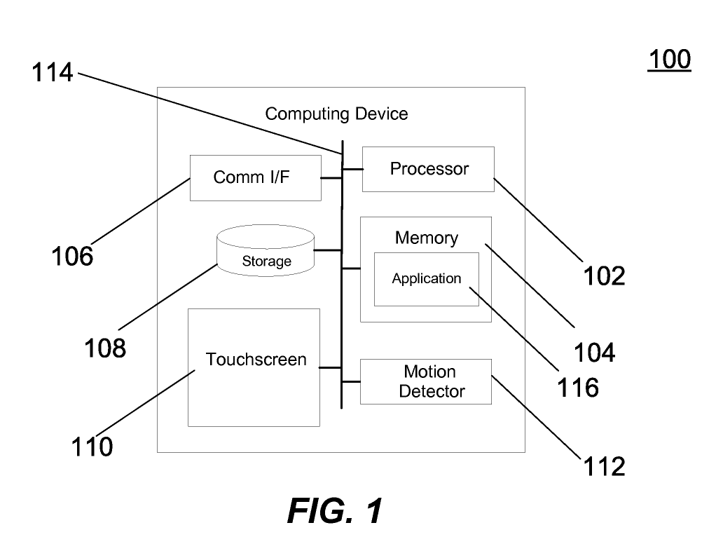

FIG. 1 shows an example computing device 100 that may be used to implement features described above. The computing device 100 includes a processor 102, memory device 104, communication interface 106, peripheral device interface 112, display device interface 110, and data storage device 108. FIG. 1 also shows a display device 110, which may be coupled to or included within the computing device 100.

The memory device 104 may be or include a device such as a Dynamic Random Access Memory (D-RAM), Static RAM (S-RAM), or other RAM or a flash memory. The data storage device 108 may be or include a hard disk, a magneto-optical medium, an optical medium such as a CD-ROM, a digital versatile disk (DVDs), or Blu-Ray disc (BD), or other type of device for electronic data storage.

The communication interface 106 may be, for example, a communications port, a wired transceiver, a wireless transceiver, and/or a network card. The communication interface 106 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 112 is configured to communicate with one or more peripheral devices. The peripheral device interface 112 operates using a technology such as Universal Serial Bus (USB), PS/2, Bluetooth, infrared, serial port, parallel port, and/or other appropriate technology. The peripheral device interface 112 may, for example, receive input data from an input device such as a keyboard, a mouse, a trackball, a touch screen, a touch pad, a stylus pad, and/or other device. Alternatively or additionally, the peripheral device interface 112 may communicate output data to a printer that is attached to the computing device 100 via the peripheral device interface 112.

The display device interface 110 may be an interface configured to communicate data to display device 110. The display device 110 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 110 may operate using technology such as Video Graphics Array (VGA), Super VGA (S-VGA), Digital Visual Interface (DVI), High-Definition Multimedia Interface (HDMI), or other appropriate technology. The display device interface 110 may communicate display data from the processor 102 to the display device 110 for display by the display device 110. As shown in FIG. 1, the display device 110 may be external to the computing device 100, and coupled to the computing device 100 via the display device interface 110. Alternatively, the display device 110 may be included in the computing device 100.

An instance of the computing device 100 of FIG. 1 may be configured to perform any feature or any combination of features described above. Alternatively or additionally, the memory device 104 and/or the data storage device 108 may store instructions which, when executed by the processor 102, cause the processor 102 to perform any feature or any combination of features described above. Alternatively or additionally, each or any of the features described above as performed may be performed by the processor 102 in conjunction with the memory device 104, communication interface 106, peripheral device interface 112, display device interface 110, and/or storage device 108.

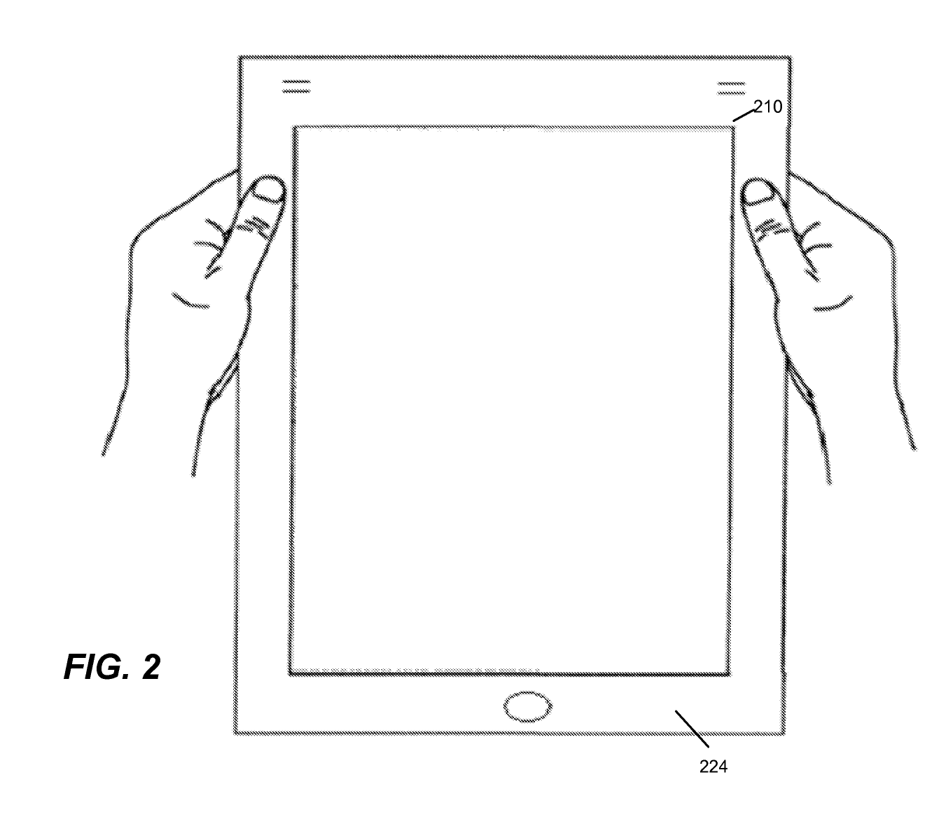

FIG. 2 shows a tablet computer 210 that is a more specific example of the computing device 100 of FIG. 1. The tablet computer 210 may include a processor (not depicted), memory device (not depicted), communication interface (not depicted), peripheral device interface (not depicted), display device interface (not depicted), storage device (not depicted), and touch screen display 224, which may possess characteristics of the processor 102, memory device 104, communication interface 106, peripheral device interface 112, display device interface 110, storage device 108, and display device 110, respectively, as described above with reference to FIG. 1. The touch screen display 224 may receive user input using technology such as, for example, resistive sensing technology, capacitive sensing technology, optical sensing technology, or any other appropriate touch-sensing technology.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described may be used alone without the other features and elements or in various combinations with or without other features and elements. Sub-elements and/or sub-steps of the methods described above may be performed in any arbitrary order (including concurrently), in any combination or sub-combination.

A system of generating uniform and independent random numbers for use within a computer system is disclosed. The system includes a processor and a communication device. The processor that operates to: take a positive integer d called modulus; take a positive integer z called multiplier coprime with d; take a positive integer n called initial value or seed coprime with d; and generates a sequence {r₁, r₂, . . . } by realizing congruence relations

r₁≡n mod(d),rⱼ₊₁≡zrⱼ mod(d),0<rⱼ<d,j=1,2, . . . Eq. 47

The communication device outputs the random number sequence {v₁, v₂, . . . } by realizing the arithmetic vⱼ=rⱼ/d for j=1, 2, . . . . The modulus d has the form of a product d=(p₁)̂(i₁)×(p₂)̂(i₂) of powers of distinct odd primes p₁, p₂ with exponents i₁ and i₂ that may take arbitrary integral values i₁≧1 and i₂≧1 excluding the case i₁=i₂=1, the odd prime p₁ gives an odd integer q₁=(p₁−1)/2, the odd prime p₂ gives an even integer q₂=(p₂−1)/2, the integers p₁, q₁, i₁, p₂, q₂, i₂ give mutually coprime integer q₁ (p₁)̂(i₁−1) and integer q₂(p₂)̂(i₂−1), the multiplier z is determined modulo d with a primitive root z₁ modulo (p₁)̂(i₁) and with a primitive root z₂ modulo (p₂)̂(i₂) either by congruence relations

z≡z₁ mod {(p₁)̂(i₁)},z≡z₂ mod {(p₂)̂(i₂)} Eq. 48

or by congruence relations

z≡−z₁ mod {(p₁)̂(i₁)},z≡z₂ mod {(p₂)̂(i₂)}, Eq. 49

and the modulus d and the multiplier z pass the 2nd and 3rd spectral test criterion of Fishman and Moore, which is the same as that the two dimensional vector v=(j₁, j₂) with integer coordinates fulfilling

j₁+zj₂≡0 mod(d) Eq. 50

and having its length ∥v∥={(j₁)²+(j₂)²}^{1/2} has the smallest positive length b₂(d, z) that satisfies b₂(d, z)>(2d)^{1/2}/(3^{1/4}μ) for μ=1.25, as well as that the three dimensional vector v=(j₁, j₂, j₃), with integer coordinates fulfilling

j₁+zj₂+z²j₃≡0 mod(d) Eq. 51

and with its length ∥v∥:={(j₁)²+(j₂)²+(j₃)²}^{1/2}, has the smallest positive length b₃(d, z) that satisfies b₃(d, z)>2^{1/6}d^{1/3}/μ.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. A system of generating uniform and independent random numbers for use within a computer system, comprising:
a processor that operates to:
take a positive integer d called modulus,
take a positive integer z called multiplier coprime with d,
take a positive integer n called initial value or seed coprime with d, and
generates a sequence {r₁, r₂, . . . } by realizing congruence relations
r₁≡n mod(d),rⱼ₊₁≡zrⱼ mod(d),0<rⱼ<d,j=1,2, . . . ; and
a communication device that outputs the random number sequence {v₁, v₂, . . . } by realizing the arithmetic vⱼ=rⱼ/d for j=1, 2, . . . ,
wherein the modulus d has the form of a product d=(p₁)̂(i₁)×(p₂)̂(i₂) of powers of distinct odd primes p₁, p₂ with exponents i₁ and i₂ that may take arbitrary integral values i₁≧1 and i₂≧1 excluding the case i₁=i₂=1, the odd prime p₁ gives an odd integer q₁=(p₁−1)/2, the odd prime p₂ gives an even integer q₂=(p₂−1)/2, the integers p₁, q₁, i₁, p₂, q₂, i₂ give mutually coprime integer q₁(p₁)̂(i₁−1) and integer q₂(p₂)̂(i₂−1), the multiplier z is determined modulo d with a primitive root z₁ modulo (p₁)̂(i₁) and with a primitive root z₂ modulo (p₂)̂(i₂) either by congruence relations
z≡z₁ mod {(p₁)̂(i₁)},z≡z₂ mod {(p₂)̂(i₂)}
or by congruence relations
z≡−z₁ mod {(p₁)̂(i₁)},z≡z₂ mod {(p₂)̂(i₂)},
and the modulus d and the multiplier z pass the 2nd and 3rd spectral test criterion of Fishman and Moore, which is the same as that the two dimensional vector v=(j₁, j₂) with integer coordinates fulfilling
j₁+zj₂≡0 mod(d)
and having its length |v|:={(j₁)²+(j₂)²}^{1/2} has the smallest positive length b₂(d, z) that satisfies b₂(d, z)>(2d)^{1/2}/(3^{1/4}μ) for μ=1.25, as well as that the three dimensional vector three dimensional vector v=(j₁, j₂, j₃), with integer coordinates fulfilling
j₁+zj₂+z²j₃≡0 mod(d)
and with its length ∥b∥:={(j₁)²+(j₂)²+(j₃)²}^{1/2}, has the smallest positive length b₃(d, z) that satisfies b₃(d, z)>2^{1/6}d^{1/3}/μ.

2. A method of generating uniform and independent random numbers for use within a computer system, comprising:
taking a positive integer d called modulus,
taking a positive integer z called multiplier coprime with d,
taking a positive integer n called initial value or seed coprime with d, and
generating, via a processor, a sequence {r₁, r₂, . . . } by realizing congruence relations
r₁≡n mod(d),rⱼ₊₁≡zrⱼ mod(d),0<rⱼ<d,j=1,2, . . . ; and
outputting, via a communication interface, the random number sequence {v₁, v₂, . . . } by realizing the arithmetic vⱼ=rⱼ/d for j=1, 2, . . . ,
wherein the modulus d has the form of a product d=(p₁)̂(i₁)×(p₂)̂(i₂) of powers of distinct odd primes p₁, p₂ with exponents i₁ and i₂ that may take arbitrary integral values i₁≧1 and i₂≧1 excluding the case i=i₂=₁, the odd prime p₁ gives an odd integer q₁=(p₁−1)/2, the odd prime p₂ gives an even integer q₂=(p₂−1)/2, the integers p₁, q₁, i₁, p₂, q₂, i₂ give mutually coprime integer q₁(p₁)̂(i₁−1) and integer q₂(p₂)̂(i₂−1), the multiplier z is determined modulo d with a primitive root z₁ modulo (p₁)̂(i₁) and with a primitive root z₂ modulo (p₂)̂(i₂) either by congruence relations
z≡z₁ mod {(p₁)̂(i₁)},z≡z₂ mod {(p₂)̂(i₂)}
or by congruence relations
z≡−z₁ mod {(p₁)̂(i₁)},z≡z₂ mod {(p₂)̂(i₂)},
and the modulus d and the multiplier z pass the 2nd and 3rd spectral test criterion of Fishman and Moore, which is the same as that the two dimensional vector v=(j₁, j₂) with integer coordinates fulfilling
j+zj₂≡0 mod(d)
and having its length ∥v∥:={(j₁)²+(j₂)²}^{1/2} has the smallest positive length b₂(d, z) that satisfies b₂(d, z)>(2d)^{1/2}/(3^{1/4}μ) for u=1.25, as well as that the three dimensional vector three dimensional vector v=(j₁, j₂, j₃), with integer coordinates fulfilling
j₁+zj₂+z²j₃≡0 mod(d)
and with its length ∥v∥:={(j₁)²+(j₂)²+(j₃)²}^{1/2}, has the smallest positive length b₃(d, z) that satisfies b₃(d, z)>2^{1/6}d^{1/3}/μ.

3. A non-transitory computer readable medium including instructions which when executed in a computing system cause the system to generate uniform and independent random numbers for use within a computer system, the method comprising:
taking a positive integer d called modulus,
taking a positive integer z called multiplier coprime with d,
taking a positive integer n called initial value or seed coprime with d, and
generating, via a processor, a sequence {r₁, r₂, . . . } by realizing congruence relations
r₁≡n mod(d),rⱼ₊₁≡zrⱼ mod(d),0<rⱼ<d,j=1,2, . . . ; and
outputting, via a communication interface, the random number sequence {v₁, v₂, . . . } by realizing the arithmetic vⱼ=rⱼ/d for j=1, 2, . . . ,
wherein the modulus d has the form of a product d=(p₁)̂(i₁)×(p₂)̂(i₂) of powers of distinct odd primes p₁, p₂ with exponents i₁ and i₂ that may take arbitrary integral values i₁≧1 and i₂≧1 excluding the case i₁=i₂=1, the odd prime p₁ gives an odd integer q₁=(p₁−1)/2, the odd prime p₂ gives an even integer q₂=(p₂−1)/2, the integers p₁, q₁, i₁, p₂, q₂, i₂ give mutually coprime integer q₁(p₁)̂(i₁−1) and integer q₂(p₂)̂(i₂−1), the multiplier z is determined modulo d with a primitive root z₁ modulo (p₁)̂(i₁) and with a primitive root z₂ modulo (p₂)̂(i₂) either by congruence relations
z≡z₁ mod {(p₁)̂(i₁)},z≡z₂ mod {(p₂)̂(i₂)}
or by congruence relations
z≡−z₁ mod {(p₁)̂(i₁)},z≡z₂ mod {(p₂)̂(i₂)},
and the modulus d and the multiplier z pass the 2nd and 3rd spectral test criterion of Fishman and Moore, which is the same as that the two dimensional vector v=(j₁, j₂) with integer coordinates fulfilling
j₁+zj₂≡0 mod(d)
and having its length ∥v∥:={(j₁)²+(j₂)²}^{1/2} has the smallest positive length b₂(d, z) that satisfies b₂(d, z)>(2d)^{1/2}/(3^{1/4}μ) for μ=1.25, as well as that the three dimensional vector v=(j₁, j₂, j₃) with integer coordinates fulfilling
j₁+zj₂+z²j₃≡0 mod(d)
and with its length ∥v∥:={(j₁)²+(j₂)²+(j₃)²}^{1/2}, has the smallest positive length b₃(d, z) that satisfies b₃(d, z)>2^{1/6}d^{1/3}/μ.
